(19) United States
(12) Patent Application Publication
(10) Pub. No.: US 2024/0324558 A1
(43) Pub. Date: Oct. 3, 2024

(54) SYSTEMS AND METHODS FOR TRACKING PETS USING ULTRA-WIDEBAND

(71) Applicant: Zooch LLC, Gross Pointe, MI (US)

(72) Inventor: Ryan P. McClellan, Grosse Pointe, MI (US)

(73) Assignee: Zooch LLC, Grosse Pointe, MI (US)

(21) Appl. No.: 18/621,394

(22) Filed: Mar. 29, 2024

Related U.S. Application Data
(60) Provisional application No. 63/493,592, filed on Mar. 31, 2023.

(51) Int. Cl. A01K 15/02; A01K 27/00

(52) U.S. Cl. CPC A01K 15/022; A01K 27/001; A01K 27/009

(57) ABSTRACT

A system comprising a plurality of anchors fixed in a building, the anchors configured to transmit and receive ultra-wideband (UWB) signals, and a wearable configured to be worn by a pet, the wearable including data processing hardware and memory hardware in communication with the data processing hardware, the memory hardware storing instructions that when executed on the data processing hardware cause the data processing hardware to perform operations comprising transmitting UWB signals to the plurality of anchors to determine a location of the wearable within the building, receiving UWB signals from the plurality of anchors to determine the location of the wearable within the building, and upon a determination that the location of the wearable is in a no-go zone, transmitting a feedback response to the pet wearing the wearable, the feedback response including at least one of an audible alert, a vibration, or a low-voltage shock.

### CROSS REFERENCE TO RELATED APPLICATIONS

This U.S. patent application claims priority under 35 U.S.C. § 119 (e) to U.S. Provisional Application No. 63/493,592, filed on Mar. 31, 2023. The disclosure of this prior application is considered part of the disclosure of this application and is hereby incorporated by reference in its entirety.

### TECHNICAL FIELD

This disclosure relates to systems and methods for tracking pets using ultra-wideband.

### BACKGROUND

Pet owners have long desired to keep their pets within a certain area or away from certain areas. Training and other traditional systems suffer from being ineffective or too burdensome. Accordingly, there is an opportunity in the art for an improved system to inhibit or allow pets to be in certain designated locations.

### SUMMARY

One aspect of the disclosure provides a system comprising a plurality of anchors fixed in a building, the anchors configured to transmit and receive ultra-wideband (UWB) signals, and a wearable configured to be worn by a pet, the wearable including data processing hardware and memory hardware in communication with the data processing hardware, the memory hardware storing instructions that when executed on the data processing hardware cause the data processing hardware to perform operations comprising transmitting UWB signals to the plurality of anchors to determine a location of the wearable within the building, receiving UWB signals from the plurality of anchors to determine the location of the wearable within the building, and upon a determination that the location of the wearable is in a no-go zone, transmitting a feedback response to the pet wearing the wearable, the feedback response including at least one of an audible alert, a vibration, or a low-voltage shock.

Implementations of the disclosure may include one or more of the following optional features. In some implementations, the operations further comprise upon a determination that the location of the wearable is in a no-solicitation zone, transmitting a feedback response to the pet wearing the wearable that is less severe than the feedback response for the no-go zone.

The operations may further comprise upon a determination that the location of the wearable is in a no-vertical zone and has exceeded a defined vertical height threshold, transmitting a feedback response to the pet wearing the wearable, the feedback response including at least one of an audible alert, a vibration, or a low-voltage shock.

The operations may further comprise upon a determination that the location of the wearable is in a no-bark zone and a sound measure obtained from the wearable has exceeded a defined sound threshold, transmitting a feedback response to the pet wearing the wearable, the feedback response including at least one of an audible alert, a vibration, or a low-voltage shock.

The system may further comprise a mobile computing device in communication with the plurality of anchors via at least one of WiFi, cellular, Bluetooth, UWB, LORA, or Sub-GHz. The mobile computing device may be configured to define a three-dimensional zone within the building by tracing the zone with the mobile computing device and transmitting the defined zone via UWB to the plurality of anchors.

Another aspect of the disclosure provides a wearable configured to be worn by a pet, the wearable comprising data processing hardware, and memory hardware in communication with the data processing hardware, the memory hardware storing instructions that when executed on the data processing hardware cause the data processing hardware to perform operations comprising transmitting ultra-wideband (UWB) signals to a plurality of anchors in a building to determine a location of the wearable within the building, receiving UWB signals from the plurality of anchors to determine the location of the wearable within the building, upon a determination that the location of the wearable is in a no-go zone, transmitting a feedback response to the pet wearing the wearable, the feedback response including at least one of an audible alert, a vibration, or a low-voltage shock, and upon a determination that the location of the wearable is in a no-solicitation zone, transmitting a feedback response to the pet wearing the wearable that is less severe than the feedback response for the no-go zone.

Implementations of the disclosure may include one or more of the following optional features. In some implementations, the wearable further comprises an accelerometer configured to determine whether the wearable is in motion or at rest. The operations may further comprise upon a determination that the wearable is in motion, transmitting UWB signals to the plurality of anchors at a first frequency, and upon a determination that the wearable is at rest, transmitting UWB signals to the plurality of anchors at a second frequency that is less than the first frequency.

The wearable may further comprise a microphone configured to obtain sound data. The operations may further comprise upon a determination that the location of the wearable is in a no-bark zone and the sound data has exceeded a defined sound threshold, transmitting a feedback response to the pet wearing the wearable, the feedback response including at least one of an audible alert, a vibration, or a low-voltage shock. The wearable may further comprise an accelerometer configured to determine a soundwave pattern associated with a bark of the pet from the sound data.

The wearable may be one of a collar, an ID tag, a harness, or an implanted chip.

The location of the wearable within the building may be determined using one of time different of arrival (TDOA), reverse TDOA, two-way ranging (TWR), or phase difference of arrival (PDOA).

Another aspect of the disclosure provides a mobile computing device comprising data processing hardware, and memory hardware in communication with the data processing hardware, the memory hardware storing instructions that when executed on the data processing hardware cause the data processing hardware to perform operations comprising communicating with a plurality of anchors in a building via a wireless network, the plurality of anchors being configured to transmit and receive ultra-wideband (UWB) signals to and from a wearable configured to be worn by a pet to determine the location of the wearable in the building, defining a zone within the building by tracing the zone with the mobile computing device and transmitting the defined zone via UWB to the plurality of anchors, and tracking the location of the wearable in the building via communication with the plurality of anchors.

Implementations of the disclosure may include one or more of the following optional features. In some implementations, the defined zone is one of two-dimensional or three-dimensional.

The operations may further comprise upon a determination that the location of the wearable is in the defined zone, receiving a notification that the wearable is in the defined zone.

The operations may further comprise defining a building perimeter by tracing the building perimeter with the mobile computing device and transmitting the defined building perimeter via UWB to the plurality of anchors.

The operations may further comprise upon a determination that the location of

the wearable is outside of the defined building perimeter, receiving a notification that the wearable is outside of the defined building perimeter. The operations may further comprise upon a determination that the location of the wearable is outside of the defined building perimeter and the location of the mobile computing device is outside of the defined building perimeter, transmitting data obtained from the wearable via Bluetooth to the plurality of anchors via at least one of WiFi, cellular, Bluetooth, UWB, LORA, or Sub-GHz.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary ultra-wideband (UWB) tracking system, as described herein.

FIG. 2 is a schematic view of an exemplary pet tracking system using ultra-wideband (UWB) technology, as described herein.

FIG. 3 is a schematic view of an exemplary room of the pet tracking system of FIG. 2.

FIG. 4 is a schematic view of an exemplary network of the pet tracking system of FIG. 2.

FIG. 5 is a schematic view of an exemplary pet wearable tag of the pet tracking system of FIG. 2.

FIG. 6 is a schematic view of an exemplary travelling pet tracking system using ultra-wideband (UWB) technology, as described herein.

FIG. 7 is a schematic view of an example computing device that may be used to implement the systems and methods described herein.

Like reference symbols in the various drawings indicate like elements.

### DETAILED DESCRIPTION

The systems and methods described herein use ultra-wideband (UWB) technology, which is a radio technology based on the Institute of Electrical and

Electronics Engineers (IEEE) 802.15.4a and 802.15.4z standards that can enable very accurate measure of the time of flight of the radio signal, leading to centimeter accuracy distance/location measurement. Additionally, UWB offers data communication while using very little energy, resulting in longer battery life than many other alternative communication systems.

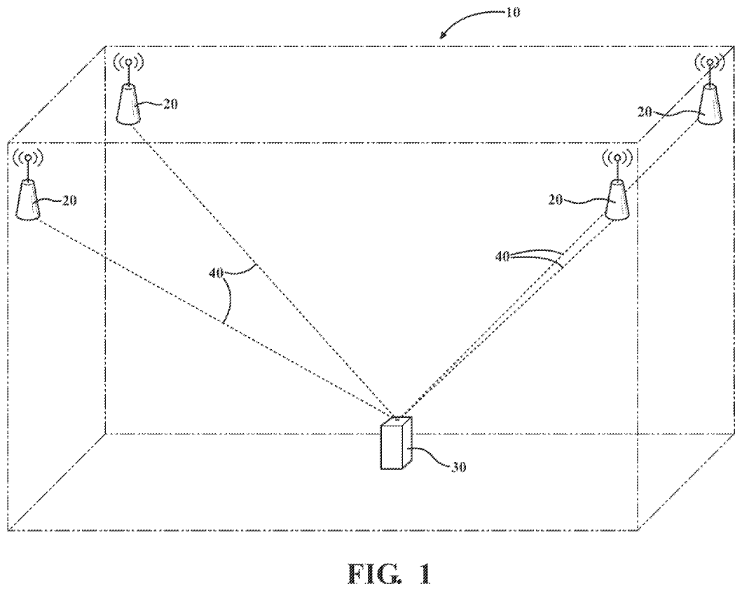

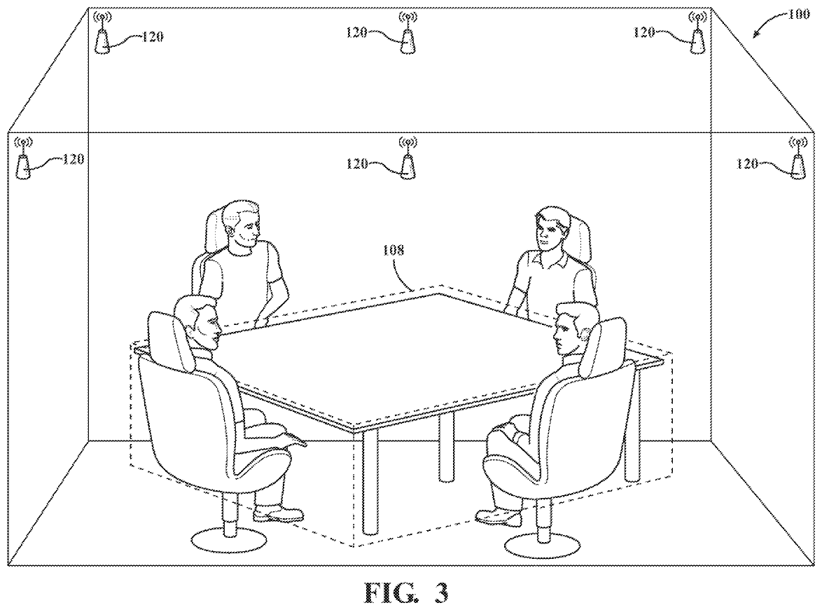

An exemplary UWB system 10 is shown in FIG. 1, which illustrates a plurality of anchors 20 and a tag 30. UWB uses one or more radio waves 40, which may be alternatively referred to as one or more UWB signals, beacon signals, blink signals or the like, to determine an XYZ-coordinate, which may alternatively be referred to as a three dimensional (3D) position or location of the tag 30. As will be explained in the following disclosure, in some implementations, the tag 30 may be associated with, joined to, or disposed within a wearable (see, e.g., a wearable 302 in FIG. 3, which may be a collar) associated with a domesticated animal or pet (e.g., a dog, cat, or the like).

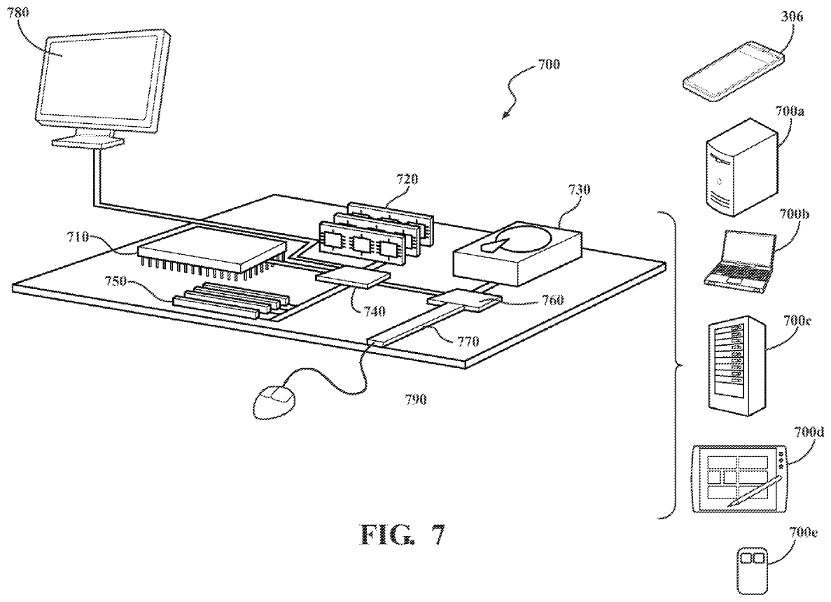

As shown in FIG. 1, the UWB system 10 may triangulate the location of the tag 30 based on the communication between the anchors 20 and the tag 30 via the radio waves 40, with data processing hardware (e.g., computing device 700, as seen in FIG. 7) of the UWB system 10 determining an XYZ-coordinate of the tag 30 based on the received location data. The UWB system 10 may determine the XYZ-coordinate/3D position or location of the tag 30 using at least one of time different of arrival (TDOA), reverse TDOA, two-way ranging (TWR), and phase difference of arrival (PDOA).

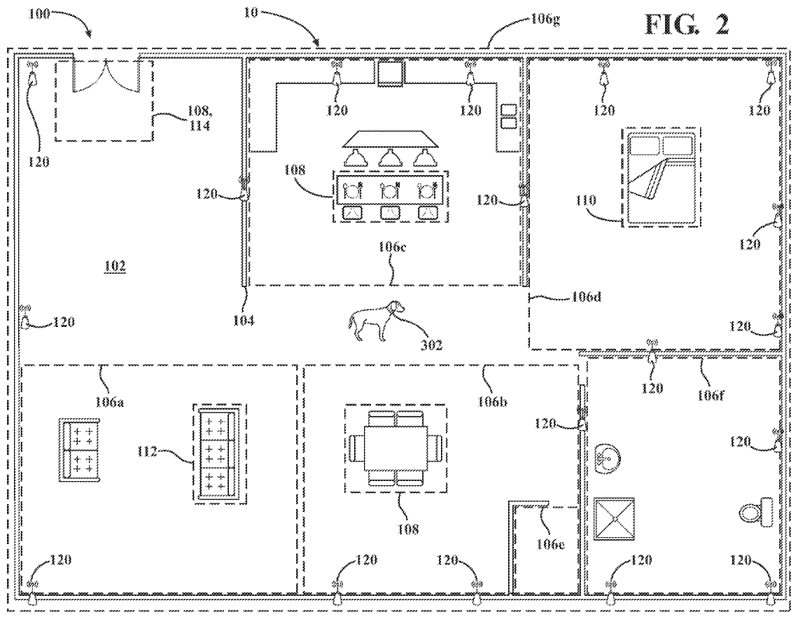

In some implementations, the TDOA method is a scalable method for determining the XYZ-coordinate/3D position or location of tags 30 within a venue (see, e.g., structure 100 in FIG. 2). Because tags 30 only need to transmit once during the process, the tags 30 use very little power and therefore have a very long battery life. In some configurations as seen at FIG. 1, multiple anchors 20 are deployed in fixed and known locations and are tightly time synchronized. When a tag 30 sends a beacon or blink signal 40, each anchor 20 that receives the signal 40 timestamps its arrival, based on the common synchronized time-base. The timestamps from multiple anchors 20 are then forwarded to data processing hardware (e.g., computing device 700, as seen at FIG. 7), which runs multilateration algorithms to determine the XYZ-coordinate/3D position or location of the tag 30 based on the differences in the time that the signal 40 arrived at each anchor 20. When there are three or more anchors 20, the result is a 3D position for the tag 30.

The reverse TDOA method operates similarly to GPS. In reverse TDOA, the anchors 20 transmit synchronized blink signals 40 (with fixed/known offsets to avoid collisions) and the tags 30 use TDOA and multilateration algorithms processed by the computing device 700 to compute the XYZ-coordinate/3D position or location of the tags 30.

In the TWR method, anchors 20 send UWB signals 40 to the tags 30, that, in turn, return the signal 40 back to the anchors 20, creating a two-way data transfer of ranging information. The data processing hardware/computing device 700 measures the time of flight of the signal 40 between each anchor 20 and the tag 30 to derive the distance between each anchor 20 and the tag 30, thereby, determining a precise XYZ-coordinate/3D position or location of the tag 30 relative to the anchors 20.

The PDOA method enables two tags 30 to calculate their relative XYZ-coordinate/3D positions or locations without the need for any other infrastructure, using a combination of distance and directional information. This may be beneficial in, for example, peer-to-peer applications or to reduce the amount of infrastructure to be deployed. For PDOA, one of the tags 30 includes at least two antennae. When the first tag 30 receives a signal 40 from the second tag 30, the first tag 30 measures the difference in the phase of the arriving signal 40 at each antenna. Based on this information, the first tag 30 can calculate the angle of arrival of the incoming signal 40. As a result, the first tag 30 is utilized for determining both the direction and the distance of the second tag 30.

Referring to FIG. 2, the UWB system 10 may be incorporated into a structure 100 such as, for example, a building, house, or the like. In some configurations, the structure 100 includes a floor 102 that extends along a plane. The floor 102 may by defined in terms of an X-coordinate direction (e.g. a width) of an XYZ Cartesian Coordinate System and a Y-coordinate direction (e.g., a length) of the XYZ Cartesian Coordinate System.

Furthermore, the structure 100 may include one or more walls 104 that extend upwardly and away from the floor 102 in a Z-coordinate direction (i.e., a height) of the XYZ Cartesian Coordinate System. The one or more walls 104 demarcate the structure 100 for defining a plurality of rooms 106. The system 10 may be configured to define a plurality of zones 106 (as described in greater detail below), which, if the structure 100 is a house, may generally correspond to rooms, furniture, or other suitable locations. For example, the system 10 may be configured to define multiple zones 106 as shown in FIG. 2, such as a living room 106a, a dining room 106b, a kitchen 106c, a bedroom 106d, a closet 106e, a bathroom 106f, and a structure perimeter 106g. As will be explained in the following disclosure, in some implementations, because the tag 30 may be associated with, joined to, or disposed within the wearable 302 of the pet, the wearable may, for example, provide training feedback (e.g., a shock, a vibration, etc.) to the pet in order to restrict or control movement of the pet within the one or more rooms 106 of the structure 100.

As seen in FIG. 2, a plurality of anchors 120 are positioned throughout the house 100 in the plurality of rooms 106. The plurality of anchors 120 may plug in flush with an external pass-through plug or may be installed in any suitable manner.

In some configurations, the plurality of anchors include a primary anchor 120a. The primary anchor 120a may be responsible for communicating with secondary anchors 120b in order to determine the location of the one or more tags 30. The secondary anchors 120b work in conjunction with the primary anchor 120a to locate the one or more tags 30. The primary anchor 120a is also responsible for communicating with a cloud server (see, e.g., network 304 in FIG. 3) for determining general movement information, storing settings and configuration information, as well as receiving software updates.

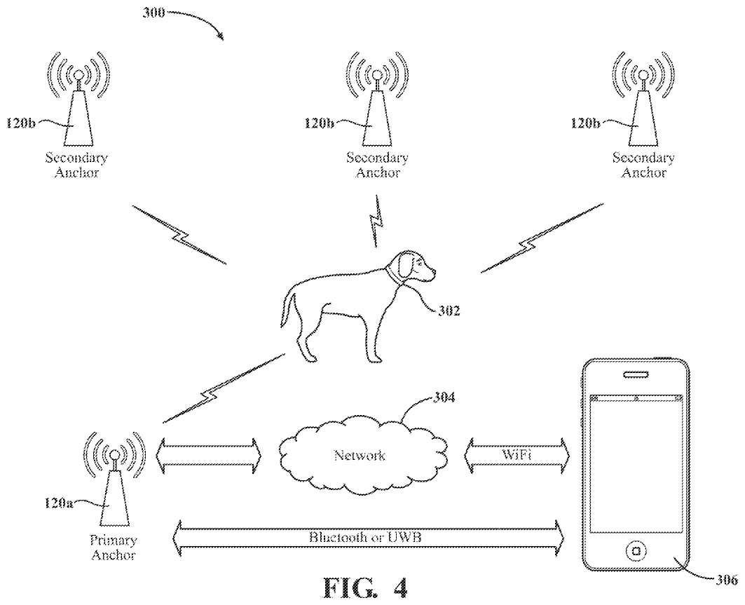

Referring to FIG. 4, a communication system 300 is generally shown. The communication system 300 includes a wearable 302 that is arranged upon a pet (e.g., a dog), and the tag 30 may be associated with, joined to, or disposed within the wearable 302. The wearable 302 may be a collar, ID tag, harness, implanted chip, etc. Furthermore, the communication system 300 may also include the plurality of anchors 120, including the primary anchor 120a, a network 304 (e.g., a router, a cloud server, Ethernet, or any combination of the foregoing), and a user interface or controller of a mobile computing device 306 (e.g., a smart phone) that communicates with the primary anchor 120a (directly or indirectly through the network 304) via WiFi, cellular, Bluetooth, UWB, LORA, or Sub-GHz. In some implementations, the mobile computing device 306 may connect directly to the wearable 302 via Bluetooth.

In some implementations, the anchors 120 may connect directly with the wearable 302 via Bluetooth to transmit data between the anchors 120 and the wearable 302. For example, the anchors 120 may detect the wearable 302 via TDOA using time sync and data sharing between the anchors 120. The system 10 may determine if the distance between one of the anchors 120 and the wearable 302 is sufficient to establish a Bluetooth connection between the particular anchor 120 and the wearable 302. If the distance is sufficient, then the system 10 may instruct the anchor 120 to connect directly with the wearable 302 via Bluetooth and use TWR to transmit ranging information between the anchor 120 and the wearable 302 to determine the location of the wearable 302.

In association with the exemplary structure 100 being a house, as seen in FIG. 4, there may be a UWB network and a secondary network. The UWB network maintains the secondary anchors 120b along with the primary anchor 120a containing the gateway and processing capabilities along with the wearable 302 that includes the tag 30. The UWB network connects through the gateway processing device via a wired or wireless connection to the secondary network, which enables the system 10 to provide cloud-based information relating to location information of the wearable 302 that includes the tag 30, and, by association, information relating to the location of the pet that bears the wearable 302. In some examples, the system 10 can be modified by utilizing the mobile computing device 306 with a direct connection to the primary anchor 120a (e.g., via Bluetooth or UWB) or the cloud interface via, for example, an application (also known as an app) or a browser that is accessible on the mobile computing device 306, which may be a smart phone or mobile phone device.

In some implementations, the system 10 is configured to detect when the pet wearing the wearable 302 enters and exits the structure 100 via detection of the wearable 302 crossing through the structure perimeter 106g. When the system 10 detects that the wearable 302 is within the structure perimeter 106g (i.e., inside the house or structure 100), the system 10 may communicate with the wearable 302 via Bluetooth unless the system 10 determines that the signal is unreliable. If the system 10 determines that the signal is unreliable, then the system switches from communicating with the wearable 302 via Bluetooth to communicating with the wearable 302 via WiFi, ESP-Now, or Sub-GHz. When the system 10 detects that the wearable 302 has exited the structure

perimeter 106g (e.g., the dog ran away or went for a walk with its owner), the system 10 communicates with the wearable 302 via Sub-GHz, LORA, or cellular, and the wearable 302 initiates GPS via a GPS module 370 with the GPS coordinates of the wearable 302 being communicated to the anchors 120 via Sub-GHz, LORA, or cellular. Additionally, when the system 10 detects that the wearable 302 has exited the structure perimeter 106g, the system 10 may deliver a notification to the mobile computing device 306 indicating that the pet has exited the structure 100. If the system 10 detects that the wearable 302 has exited the structure perimeter 106g and the mobile computing device 306 has also exited the structure perimeter 106g (indicating that the pet owner is accompanying the pet), the system 10 may not deliver any notification to the mobile computing device 306, and the system 10 may switch to communicating directly with the mobile computing device 306, which communicates with the wearable 302 via Bluetooth. In such implementations, GPS tracking, coordinates, accelerometer data, etc., of the wearable 302 are transmitted to the mobile computing device 306 via Bluetooth and the mobile computing device 306 transmits the data to the primary anchor 120a through cellular connection with the cloud network 304.

When the system 10 detects that the wearable 302 has returned to the structure 100, i.e., detects that the wearable is within the structure perimeter 106g, then the system 10 instructs the wearable 302 to turn off GPS to conserve battery.

In regards to a travelling zone system 150 described further below, the wearable 302 connects peer-to-peer with the mobile computing device 306 via UWB or a remote control 700e using PDOA. The wearable 302 may connect to the mobile computing device 306, the remote 700e, or both if configuration is needed. It is possible that the user interface can connect to the remote 700e via a Bluetooth connection to make changes to identified zones within the structure 100.

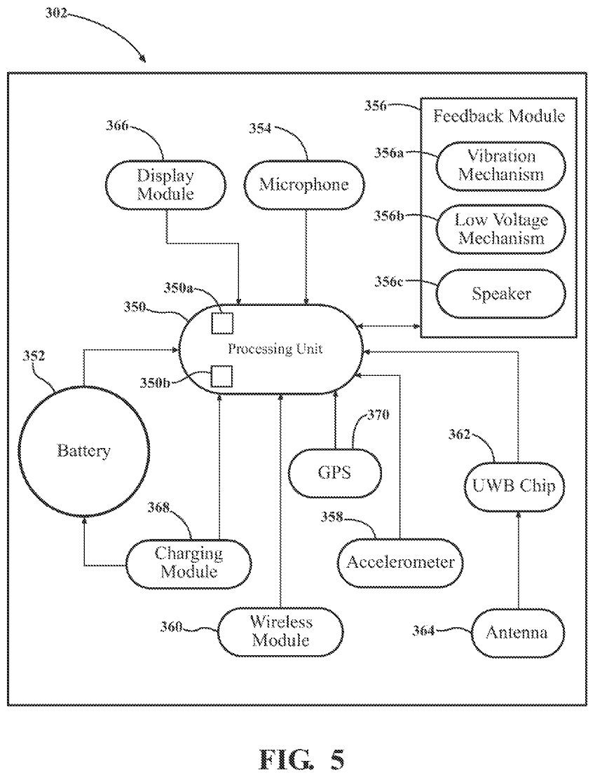

Referring to FIG. 5, in some implementations, the wearable 302 may include a processing unit 350 and associated hardware (i.e., data processing hardware 350a and memory 350b), a battery 352, a microphone 354, a feedback module 356, including a vibration mechanism 356a, a low voltage mechanism 356b, and a speaker 356c, an accelerometer or gyroscope 358, a wireless module 360, a UWB chip 362, one or more antennae 364 in communication with the UWB chip 362, an optional on/off button, a display 366 such as, for example, a liquid crystal display (LCD) screen, an optional program button, a charging module 368 including a charging port or charging mechanism, and a GPS module 370.

The data processing hardware 350a may process instructions for execution within the wearable 302, including instructions stored in the memory 350b. The battery 352 powers the wearable 302 and is in communication with the charging module 368 to recharge the battery 352 when a cable is connected to the charging port. The microphone 354 is configured to detect sound, e.g., barks from the dog wearing the wearable 302 and transmit sound data to the processing unit 350. The feedback module 356 is configured to receive instructions from the processing unit 350 and deliver training feedback responses to the pet wearing the wearable 352 including a vibration through the vibration mechanism 356a, a shock through the low voltage mechanism 356b, and a sound or beep through the speaker 356c. In some implementations, the sound delivered through the speaker 356c may be transmitted at a frequency that is only audible to dogs and not to humans (e.g., 23 to 54 kHz). The accelerometer 358 is configured to detect motion of the pet wearing the wearable 302 and transmit accelerometer data to the processing unit 350. In some implementations, the accelerometer 358 may include, or be in communication with, a barometric pressure sensor (BPS) configured to determine a barometric pressure at the wearable 302 and transmit barometric pressure data to the processing unit 350. The system 10 may determine a location of the wearable 302, particularly an altitude or location in the Z-coordinate, based on the barometric pressure data, which, in some implementations, may be augmented or supplemented by the accelerometer data from the accelerometer 358. In some implementations, the system 10 may determine which floor of the structure 100 the wearable 302 is located (e.g., first floor, second floor, etc.) based on the barometric pressure data and/or the accelerometer data, and then the system 10 may throttle-down the frequency of, or suspend, collection of the barometric pressure data to conserve battery. The wireless module 360 is configured to connect to, and communicate with, one or more devices and/or anchors 120 via Bluetooth, WiFI, ESP-Now, Sub-GHz, LoRa, or cellular. The UWB chip 362 is configured to connect to, and communicate with, one or more devices and/or anchors 120 via UWB and the one or more antennae 364. The LCD screen 366 of the wearable 302 may illustrate the name of the user and/or the pet, the battery life of the tag 30, or the like. If the pet is in a zone where it cannot communicate with the anchors 120, the name of the pet, the address of the user/the owner of the pet, and any other information such as a phone number of the user/the owner of the pet, etc., may be displayed on the LCD screen 366. The GPS module 370 is configured to communicate with GPS satellites to locate the wearable 302.

The remote control 700e may include a battery, an UWB chip, one or more antennae, a processing unit and associated hardware, an optional accelerometer, a Bluetooth module, an on/off button, a LCD screen, one or more buttons and/or toggle switches, and a charging port or mechanism. The remote control 700e may be incorporated into the mobile computing device 306 (e.g., as an app), or it may be a separate device.

As described above, the system 10 may define zones 106 whereby one or more of the zones 106 may be further defined by an XYZ Cartesian Coordinate System or 3D space. Therefore, the system 10 provides for the ability to determine if, for example, the pet (that bears the wearable 302) approaches, or is located near or upon, a furnishing within the one or more zones, which may include, for example, a couch in the living room 106a, under a bed in the bedroom 106d, a countertop in the kitchen 106c, etc. In some instances, a user of the system may access the mobile computing device 306 in order to define or create one or more zones while further programming the wearable 302 to provide training feedback to the pet that bears the wearable 302. Furthermore, in other examples, the zones may be associated with day/time restrictions, or have independent settings/zones based on the multiple collars (i.e., multiple pets each bearing a unique wearable 302 within the structure 100). Exemplary settings may include zone name, zone category, such as vertical zone, no-go zone, no-go zone with early warning, no-solicitation zone, no-bark zone, etc., feedback selection, such as enable beep (gradual or static), enable vibration (gradual or static), enable shock (gradual or static), allow for automated feedback based on severity, etc., and day/time active. Zones can be configured globally and then each region can be configured individually. When the system 10 detects that the wearable 302 is approaching, has entered, or has exited a defined zone, the system 10 may deliver a notification to the mobile computing device 306 indicating the status of the wearable 302 with respect to the specific zone.

In order to configure a zone, the user may utilize the mobile computing device 306 and/or the remote control 700e. First, the user inputs a name for the desired zone. Next, the user chooses a zone type. Next, the user holds down a learn button on the mobile computing device 306 and/or the remote control 700e while the mobile app instructs the user how to trace the zone using the mobile computing device 306 and/or the remote control 700e. Next, the system 10 confirms that the zone creation is correct based on system parameters. Next, the user accepts the general feedback for the zone or creates a custom feedback. Next, the system 10 may ask additional questions such as vertical dimensions (e.g., a Z-coordinate direction (e.g., a height) limitation of the XYZ Cartesian Coordinate System) of the zone or range for early warning. Finally, the system 10 saves the defined zone.

Referring to FIGS. 2 and 3, a user of the system 10 may elect to, for example, define a no-vertical zone 108, e.g., in the dining room 106b (table) and or the kitchen 106c (counter). The user of the system 10 may also elect to define, for example, an area near the front door as a no-vertical zone 108 if the pet is predisposed to jump on guests upon entry into the structure 100. Because the tag 30 may be may be associated with, joined to, or disposed within the wearable 302, the system 10 is able to detect a change in the Z-coordinate location of the wearable by utilizing one or a combination of the height location of the wearable 302, information from the accelerometer or gyroscope 358, and/or barometric pressure data from the BPS in order to determine if the pet deviated from a horizontal orientation proximate the floor 102 to a vertical orientation away from the floor 102. The system 10 also provides for the ability to program an X-coordinate location for the pet that indicates the height range in which the pet is vertical. In some instances, artificial intelligence (AI) may also be enabled to automatically learn vertical metrics associated with the pet that bears the wearable 302. In some examples, when the pet bearing the wearable 302 is located within a particular zone and has deviated away from the floor 102, the system 10 may trigger a feedback response through the wearable 302.

In configuring a no-vertical zone 108, while in a learning mode, the user may move the remote 700e or mobile computing device 306, across the back of the countertop in the kitchen 106c and then around to the front of the countertop in the kitchen 106c, tracing a perimeter and ending with a contiguous line. The system 10 tracks the location of the remote 700e or mobile computing device 306 (via UWB communication) throughout this tracing process to define the no-vertical zone 108.

Referring to FIG. 2, the system 10 may be configured to define a no-go zone 110 (e.g., the bed in the bedroom zone 106d). In the no-gone zone 110, the system 10 may be configured to provide a more aggressive feedback for the pet. Examples of no-go zones may include, for example, the front door of an apartment, a location of a rubbish bin, a shoe rack, or the like. The system 10 may also provide a no-go zone with an early warning feedback response. For example, if a user would prefer that the pet is to not be near the front door for reason of the pet independently electing to escape from the structure 100, the user may identify a region of the structure 100 proximate the front door as a no-go zone with early warning. That is, the system 10 is configured to provide a feedback response (via the feedback module 356) to the pet when the system 10 detects that the animal is approaching the no-go zone 110, and the system 10 may deliver a more aggressive feedback response as the pet gets closer to the no-go zone 110, and an even more aggressive response once the pet passes into the no-go zone 110. The system 10 may deliver immediate feedback if the pet crosses over a defined barrier that demarcates a permitted zone from a no-go zone 110. If, for example, the pet is a cat, this type of zone may be used for cupboards or areas where the pet might be allowed to get close to but not enter.

The user may configure these zones by utilizing the remote 700e while in learning mode to trace the inner frame of the space. Thereafter, the user may tap to define the safe side of the virtual barrier. The zone range for early warning can be adjusted by region. This procedure may be automated, or the user can manually create the zone using the learning function.

Referring to FIG. 2, the system 10 may be configured to define a no-solicitation zone 112 (e.g., the couch in the living room zone 106a) for providing a lesser degree of feedback response than a no-go zone. Generally, a no-solicitation zone 112 may be an area where a pet is permitted to roam; however, the user of the system 10 may selectively prefer that the pet may not be permitted access to such regions (e.g., a dining room 106b or kitchen 106c) under certain situations (e.g., when the pet owner is having a meal, such as breakfast, lunch, or dinner). In these instances, training feedback (via the feedback module 356) provided to the pet might be less severe than the no-go zone 110. For example, the training feedback for the no-solicitation zone 112 may be an audible alert (e.g., the wearable 302 may include the speaker 356c that produces a beeping sound, the vibration mechanism 356a that produces a light vibration, or the like) until the pet leaves the no-solicitation zone 112. Generally, these zones may be defined by a region of the floor 102 that includes all of or a portion of the dining room 106b, a couch located in the living room 106a, or a bed located in the bedroom 106d.

In some examples, if a user would prefer that their dog does not beg for human food during meals, the user may create a no-solicitation zone 112 near a table that is located in the dining room 106b, or, for example an island countertop area in the kitchen 106c. These zones would also allow a user to create a Z-coordinate direction (e.g., a height) limitation in the no-solicitation zone, which may allow, for example, a pet to crawl under a bed in the bedroom 106d, but not at a vertical distance away from the floor 102, whereby, the pet could be positioned upon the bed.

Referring to FIG. 2, in some instances, the system 10 may be configured to define a no-bark zone 114 (e.g., at the entrance to the structure 100). In some implementations, the wearable 302 may be configured to include the microphone 354 (or another sound level meter) in order to measure sound pressure level (i.e., in decibels) that may be associated with the sound of, for example, a dog barking. Accordingly, if the wearable 302 determines that the pet is producing an unwanted sound in one or more zones of the structure 100, the wearable 302 may be configured to provide training feedback to the pet that bears the wearable 302 in order to create a no-bark zone 114. Similar to the process described above, the user, in learning mode while configuring a region, may trace the ground area in which the user would like to create the no-bark zone 114, and the system 10 may automatically recognize that spatially defined region as the no-bark zone 114 and assign it the desired attributes. For example, the attributes may include providing training feedback to the pet through the wearable 302 when the system 10 detects the pet within the no-bark zone 114 and the wearable 302 detects a bark from the pet.

The user may input pet parameters regarding the pet such as breed, weight, etc., and the feedback module 356, based on the parameters, may gradually increase the strength based on the pet's response to the training feedback. For example, if the user located a rubbish bin in a cabinet under a sink in the kitchen 106c, the user may program this region of the structure 100 as a no-go zone 110 without early warning. If, however, the pet is detected within the no-go zone 110 for a pre-determined amount of time without leaving the no-go zone 110 (e.g., 10 seconds, 20 seconds, etc.), the system 10 may transmit more rapid and/or increasing feedback to the pet through the wearable 302 until the system 10 detects that the pet has left the no-go zone 110. The system 10 may also determine a maximum training feedback based on the pet parameters regarding breed, weight, etc. For example, the system 10 may provide training feedback for a 15 pound dog that is less severe than the training feedback for a 100 pound dog.

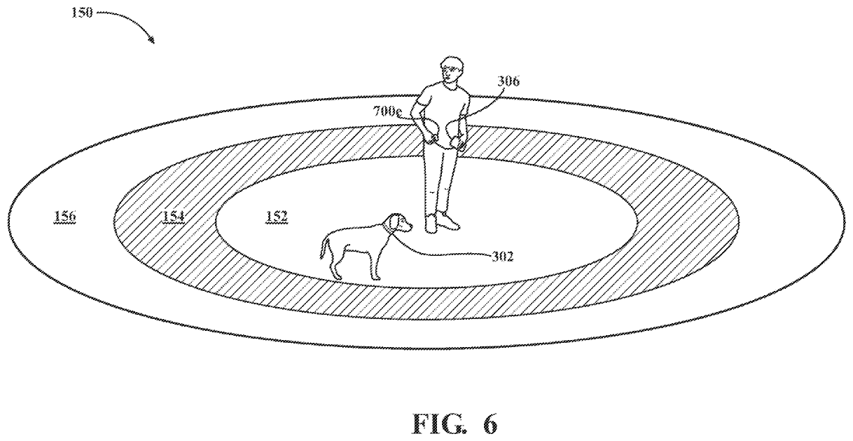

Referring to FIG. 6, an exemplary travelling zone system 150 is shown, which may be associated with the mobile computing device 306 and/or the remote control 700e. The travelling zone system 150 may operate similarly to the system 10 described above, but in a mobile environment, rather than a fixed environment.

As seen in FIG. 6, the travelling zone may be provided when a user is outside of the structure 100, e.g., on a walk with their pet. In such an implementation, the travelling zone system 150 restricts the pet from moving beyond a predetermined range away from a location of the user's mobile computing device 306. The mobile computing device 306 may accompany the remote 700e to make changes as desired by the user. The mobile computing device 306 may connect to the remote 700e via Bluetooth or UWB. There travelling zone system 150 may also permit the user to define the travelling zone via the remote 700e without the use of the mobile computing device 306. In such implementations, the remote 700e may include a visual display, settings buttons, and optionally a wheel to allow it to define zone perimeters and intensity levels at each point. The remote 700e may also allow the user to choose a gradual training feedback response or a static response, as set forth above.

As seen in FIG. 6, the travelling zone system 150 may define a central no-feedback zone (or safe zone) 152 surrounding the user having the mobile computing device 306 and/or the remote 700e and two feedback zones defined by a first-warning zone 154 surrounding the safe zone 152 and a second-warning zone 156 surrounding the first-warning zone 154. The zones 152, 154, 156 may have a generally circular shape or any other suitable shape, such as elliptical, rectangular, etc. For example, the travelling zone system 150 may determine a travelling path of the user based on accelerometer data, gyroscope data, and or GPS data and configure the zones 152, 154, 156 as rectangular shapes with the mobile computing device 306 and/or the remote 700e acting as an anchor at the center of the rectangles. This may be beneficial for when the user is walking on a street or sidewalk and desires the zones 152, 154, 156 to align with the confines of the street or sidewalk. In some implementations, the travelling zone system 150, based on accelerometer data, gyroscope data, and or GPS data, may determine whether the user is travelling around a corner and may adjust the size and/or shape of the zones 152, 154, 156 in response. As just one example, the travelling zone system 150, based on accelerometer data, gyroscope data, and or GPS data, may implement the zones 152, 154, 156 as rectangular when the mobile computing device 306 and/or the remote 700e are in motion and may change the shape of the zones 152, 154, 156 to be circular when the mobile computing device 306 and/or the remote 700e are at rest. As another example, if the travelling zone system 150 cannot determine an accurate travelling path with a pre-determined threshold of confidence, the travelling zone system 150 may configure the zones 152, 154, 156 as circular in shape by default.

The range (i.e., the distance from the mobile computing device 306) of each zone may be adjusted independently as well as the desired training feedback responses imposed upon the pet for deviating away from the safe zone 152, where no training feedback response is provided to the pet through the wearable 302. For example, when the travelling zone system 150 detects the wearable 302 in the safe zone 152, the travelling zone system 150 does not transmit any training feedback to the pet through the wearable 302 as the pet is in the desired region (i.e., desired distance from the mobile computing device 306). When the travelling zone system 150 detects the wearable 302 in the first-warning zone 154, the travelling zone system 150 may instruct the wearable 302 to provide the pet with a minor feedback response (e.g., a beep, a slight vibration, etc.). When the travelling zone system 150 detects the wearable 302 in the second-warning zone 156 and beyond, the travelling zone system 150 may instruct the wearable 302 to provide the pet with a more aggressive feedback response (e.g., a louder beep, a greater vibration, a shock, etc.) than that of the first-warning zone 154. In some implementations, when the travelling zone system 150 detects that the wearable 302 is travelling in a direction away from the safe zone 152, the travelling zone system 150 may instruct the wearable 302 to provide the pet with gradually increasing feedback responses as the pet continues to move further away from each zone 152, 154, 156. Similarly, when the travelling zone system 150 detects that the wearable 302 is travelling in a direction toward the safe zone 152, the travelling zone system 150 may instruct the wearable 302 to provide the pet with gradually decreasing feedback responses as the pet continues to move from the second-warning zone 156, through the first-warning zone 154, and into the safe zone 152.

Energy conservation of components of the system 10, such as, for example, the tag 30, which may be may be associated with, joined to, or disposed within the wearable 302 may be achieved by optimization of the tag's battery 352. However, due to the frequency that pulses are emitted from the tag 30 and the other drains on the battery arising from the feedback mechanism 356 of the wearable 302, as well as the operation of LCD 366 and the like, a way to conserve energy is to manage the pulse logic.

In some instances, operation of the accelerometer 358 may be utilized for managing the pulse frequency. For example, when the system 10 detects that the wearable 302 and the pet is not in motion (via the accelerometer 358), the system 10 may instruct the wearable 302 to transmit UWB pulses at a low frequency or to enter sleep mode where no UWB pulses are transmitted. The system 10 may instruct the wearable 302 to stay in this setting until the system 10 detects that the wearable 302 and the animal is in motion (via the accelerometer 358). Thus, when the system 10 detects that the pet is moving or approaching a zone, the system 10 may transition to wake mode in order to improve location accuracy of the wearable 302, and, by extension, the location of the pet.

In a first example, when the system 10 determines that the pet is at rest via the accelerometer 358 of the wearable 302, the wearable 302 may transmit UWB pulses at a frequency of approximately once every 5 seconds. In a second example, when the system 10 determines that the pet is in motion via the accelerometer 358 of the wearable 302, the wearable 302 may transmit UWB pulses at a frequency of approximately once every 50 milliseconds. In a third example, when the system 10 determines that the pet is approaching a zone via tracking of the wearable 302, the wearable 302 may transmit UWB pulses at a frequency of approximately once every 10 milliseconds. In a fourth example, when the system 10 determines that the pet is in a zone via tracking of the wearable 302, the wearable 302 may transmit UWB pulses at a frequency of approximately once every 10 milliseconds, and the system 10 may also conduct further accuracy tests to determine whether a change of methodology is required. In a fifth example, when the system 10 determines that the accuracy of the location of the wearable 302 is not ideal or there is low confidence associated with the accuracy of the location of the wearable 302, the system 10 may switch from TDOA to reverse TDOA or TWR.

The travelling zone system 150 may use PDOA to determine distance and location of the wearable 302, and, by extension, the pet bearing the wearable 302. The travelling zone system 150 may also utilize the accelerometer 358 of the wearable 302 to monitor a Z-coordinate direction (e.g., a height) of the pet.

The system 10 may include feedback logic in one or more of the wearable 302 (e.g., the processing unit 350 and the feedback module 356), the mobile computing device 306 (e.g., processor 710), and/or the remote 700e (e.g., processor 710) to determine how feedback is applied to the pet through the wearable 302. The feedback logic may vary from the approach at which the pet is moving towards a zone, or if the pet is in the zone. As one example, the system 10 may initiate an early warning system for a no-go zone 110 including the speaker 356c associated with the wearable 302 producing a beeping sound and then the vibration mechanism 356a producing a gradual vibration from a distance within 3 feet of the no-go zone 110 until 1 foot of the no-go zone 110. Once the pet comes within (or is at a distance less than) 1 foot of the no-go zone 110, the wearable 302 may produce a shock via the low voltage mechanism 356b in order to provide training feedback to the pet. As another example, a bed located within the bedroom 106d may be deemed by a user to provide a less severe form of training feedback to the pet as a no-solicitation zone 112, whereby the system 10 instructs the wearable 302 to produce a beeping sound through the speaker 356c that gets progressively louder as the pet approaches the bed in addition to the wearable 302 also producing a vibration through the vibration mechanism 356a. The system 10 may gradually dissipate one or both of the sound and vibration provided by the wearable 302 as the pet progresses towards the edge of the barrier of the no-solicitation zone 112. If the pet remains near the edge of the barrier of the no-solicitation zone 112 or within the barrier of the no-solicitation zone 112, the system 10 may transmit to the pet through the wearable a quick or more intense training feedback response in the form of a vibration through the vibration mechanism 356a and/or a shock through the low voltage mechanism 356b depending on the desired configuration of the system 10 as deemed by the user.

In some configurations, the system 10 may also utilize the accelerometer 358 to determine a soundwave pattern that occurs with the pet producing a sound, such as, for example, a barking sound. The system 10 may learn this information and build an algorithm associated with the barking sound, which may allow the user/owner of the pet to set bark restrictions. The purpose of the double verification is to not penalize the pet should outside noises, or other dogs, match the sound of the pet's unique bark signature defined by one or more record soundwaves stored in the system 10. These bark restrictions can be used at all times, during certain times of a day, or even at certain locations.

FIG. 7 is a schematic view of an example computing device 700 that may be used to implement the systems 10 and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as the mobile computing device 306, as a standard server 700a or multiple times in a group of such servers 700a, as a laptop computer 700b, as part of a rack server system 700c, as part of a table computer 700d, or as the remote 700e.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A system comprising:
a plurality of anchors fixed in a building, the anchors configured to transmit and receive ultra-wideband (UWB) signals; and
a wearable configured to be worn by a pet, the wearable including data processing hardware and memory hardware in communication with the data processing hardware, the memory hardware storing instructions that when executed on the data processing hardware cause the data processing hardware to perform operations comprising:
transmitting UWB signals to the plurality of anchors to determine a location of the wearable within the building;
receiving UWB signals from the plurality of anchors to determine the location of the wearable within the building; and
upon a determination that the location of the wearable is in a no-go zone, transmitting a feedback response to the pet wearing the wearable, the feedback response including at least one of an audible alert, a vibration, or a low-voltage shock.

2. The system of claim 1, wherein the operations further comprise upon a determination that the location of the wearable is in a no-solicitation zone, transmitting a feedback response to the pet wearing the wearable that is less severe than the feedback response for the no-go zone.

3. The system of claim 1, wherein the operations further comprise upon a determination that the location of the wearable is in a no-vertical zone and has exceeded a defined vertical height threshold, transmitting a feedback response to the pet wearing the wearable, the feedback response including at least one of an audible alert, a vibration, or a low-voltage shock.

4. The system of claim 1, wherein the operations further comprise upon a determination that the location of the wearable is in a no-bark zone and a sound measure obtained from the wearable has exceeded a defined sound threshold, transmitting a feedback response to the pet wearing the wearable, the feedback response including at least one of an audible alert, a vibration, or a low-voltage shock.

5. The system of claim 1, further comprising a mobile computing device in communication with the plurality of anchors via at least one of WiFi, cellular, Bluetooth, UWB, LORA, or Sub-GHz.

6. The system of claim 5, wherein the mobile computing device is configured to define a three-dimensional zone within the building by tracing the zone with the mobile computing device and transmitting the defined zone via UWB to the plurality of anchors.

7. A wearable configured to be worn by a pet, the wearable comprising:
data processing hardware; and
memory hardware in communication with the data processing hardware, the memory hardware storing instructions that when executed on the data processing hardware cause the data processing hardware to perform operations comprising:
transmitting ultra-wideband (UWB) signals to a plurality of anchors in a building to determine a location of the wearable within the building;
receiving UWB signals from the plurality of anchors to determine the location of the wearable within the building;
upon a determination that the location of the wearable is in a no-go zone, transmitting a feedback response to the pet wearing the wearable, the feedback response including at least one of an audible alert, a vibration, or a low-voltage shock; and
upon a determination that the location of the wearable is in a no-solicitation zone, transmitting a feedback response to the pet wearing the wearable that is less severe than the feedback response for the no-go zone.

8. The wearable of claim 7, further comprising an accelerometer configured to determine whether the wearable is in motion or at rest.

9. The wearable of claim 8, wherein the operations further comprise upon a determination that the wearable is in motion, transmitting UWB signals to the plurality of anchors at a first frequency, and upon a determination that the wearable is at rest, transmitting UWB signals to the plurality of anchors at a second frequency that is less than the first frequency.

10. The wearable of claim 7, further comprising a microphone configured to obtain sound data.

11. The wearable of claim 10, wherein the operations further comprise upon a determination that the location of the wearable is in a no-bark zone and the sound data has exceeded a defined sound threshold, transmitting a feedback response to the pet wearing the wearable, the feedback response including at least one of an audible alert, a vibration, or a low-voltage shock.

12. The wearable of claim 11, further comprising an accelerometer configured to determine a soundwave pattern associated with a bark of the pet from the sound data.

13. The wearable of claim 7, wherein the wearable is one of a collar, an ID tag, a harness, or an implanted chip.

14. The wearable of claim 7, wherein the location of the wearable within the building is determined using one of time different of arrival (TDOA), reverse TDOA, two-way ranging (TWR), or phase difference of arrival (PDOA).

15. A mobile computing device comprising:
data processing hardware; and
memory hardware in communication with the data processing hardware, the memory hardware storing instructions that when executed on the data processing hardware cause the data processing hardware to perform operations comprising:
communicating with a plurality of anchors in a building via a wireless network, the plurality of anchors being configured to transmit and receive ultra-wideband (UWB) signals to and from a wearable configured to be worn by a pet to determine the location of the wearable in the building;
defining a zone within the building by tracing the zone with the mobile computing device and transmitting the defined zone via UWB to the plurality of anchors; and
tracking the location of the wearable in the building via communication with the plurality of anchors.

16. The mobile computing device of claim 15, wherein the defined zone is one of two-dimensional or three-dimensional.

17. The mobile computing device of claim 15, wherein the operations further comprise upon a determination that the location of the wearable is in the defined zone, receiving a notification that the wearable is in the defined zone.

18. The mobile computing device of claim 15, wherein the operations further comprise defining a building perimeter by tracing the building perimeter with the mobile computing device and transmitting the defined building perimeter via UWB to the plurality of anchors.

19. The mobile computing device of claim 18, wherein the operations further comprise upon a determination that the location of the wearable is outside of the defined building perimeter, receiving a notification that the wearable is outside of the defined building perimeter.

20. The mobile computing device of claim 19, wherein the operations further comprise upon a determination that the location of the wearable is outside of the defined building perimeter and the location of the mobile computing device is outside of the defined building perimeter, transmitting data obtained from the wearable via Bluetooth to the plurality of anchors via at least one of WiFi, cellular, Bluetooth, UWB, LORA, or Sub-GHz.
